(19) United States
(12) Patent Application Publication
(10) Pub. No.: US 2004/0049493 A1
(43) Pub. Date: Mar. 11, 2004

(54) String matching process for ASCII strings using two arrays and hash table

(76) Inventor: Andrew Davis, Santa Cruz, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/236,365

(22) Filed: Sep. 5, 2002

(51) Int. Cl. G06F 7/00

(52) U.S. Cl. 707/3

(57) ABSTRACT

A method of recognizing an input string is disclosed. The method entails searching a prefix length table (PLT) for lengths of potential matching strings using one or more characters of the input string, generating hash keys respectively comprising the input string and lengths of potential matching strings, and searching a hash table using the hash keys to find a hash entry containing a string matching the input string.

### FIELD OF THE INVENTION

This invention relates generally to computer network devices, and in particular, to a content-based routing or other techniques using a string matching process for ASCII strings using two arrays and a hash table.

### BACKGROUND OF THE INVENTION

Packet routing techniques have been given much attention over the last several years. Techniques have been developed to route data packets based on media access control (MAC) and Internet protocol (IP) information. Recently, however, there has been a need for routing techniques that are based on the string content of the data packet. For instance, if the data packet is intended for a particular person, then a packet routing technique would access and recognize the name data contained in the packet, and route the data packet to an appropriate port which leads to a device pertaining to that person. Other applications for string recognition may also be contemplated.

### SUMMARY OF THE INVENTION

An aspect of the invention relates to a method of recognizing an input string. In summary, the method entails searching a prefix length table (PLT) for lengths of potential matching strings using one or more characters of the input string, generating hash keys respectively comprising the input string and lengths of potential matching strings, and searching a hash table using the hash keys to find a hash entry containing a string matching the input string.

The method may further include determining whether the input string is a valid string. This may entail a start string table (SST) containing first characters of valid strings. The input string may be a portion of a total string, wherein each of the hash keys further comprises an index indicating the order sequence of the input string within said total string. The hash entry may include a parameter indicating that there are no further strings to search. Or, the hash entry may include one or more lengths of potential matching strings that continue the input string.

Also disclosed is a content-based routing device that uses the string matching method in accordance with the invention. Other aspects, features and techniques of the invention will become apparent to one skilled in the relevant art in view of the following detailed description of the invention.

### BRIEF DESCRIPTION OF THE DRAWINGS

FIG. 1 illustrates a flow diagram of an exemplary string matching method in accordance with an embodiment of the invention;

FIG. 2 illustrates an exemplary start string table (SST) in accordance with another embodiment of the invention;

FIG. 3 illustrates an exemplary prefix lengths table (PLT) in accordance with another embodiment of the invention;

FIG. 4 illustrates an exemplary hash table in the form of a parse tree in accordance with another embodiment of the invention; and

FIG. 5 illustrates a block diagram of an exemplary routing device in accordance with another embodiment of the invention.

### DETAILED DESCRIPTION OF THE INVENTION

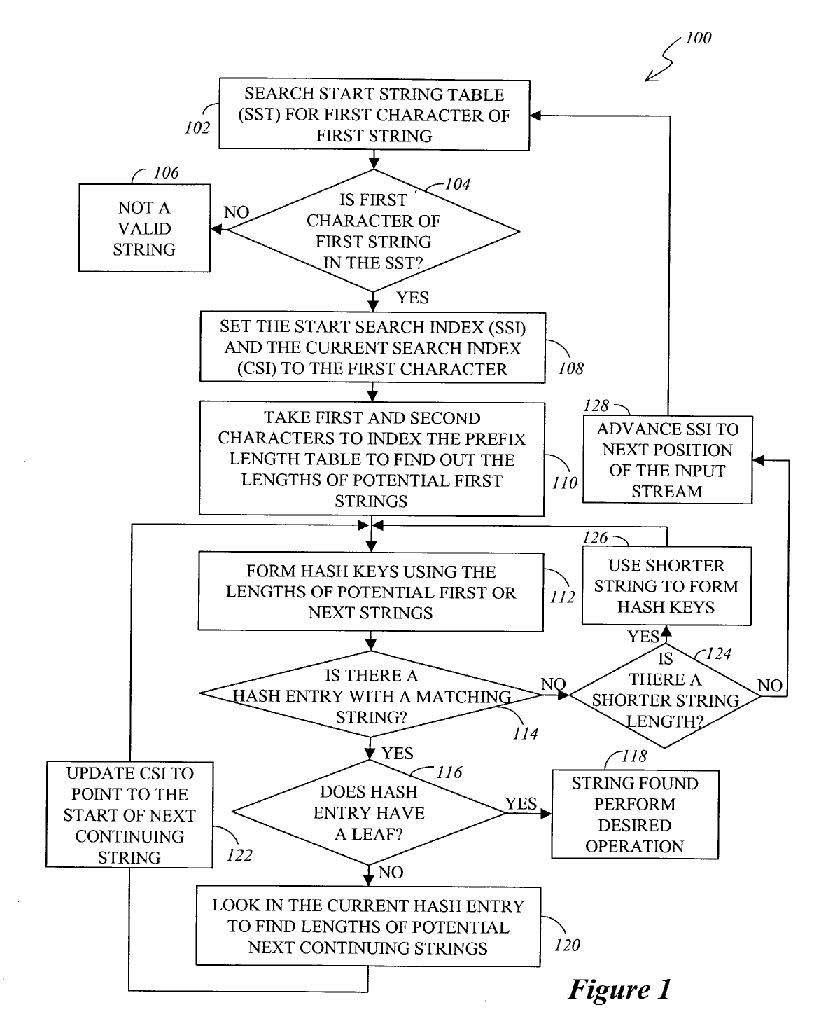

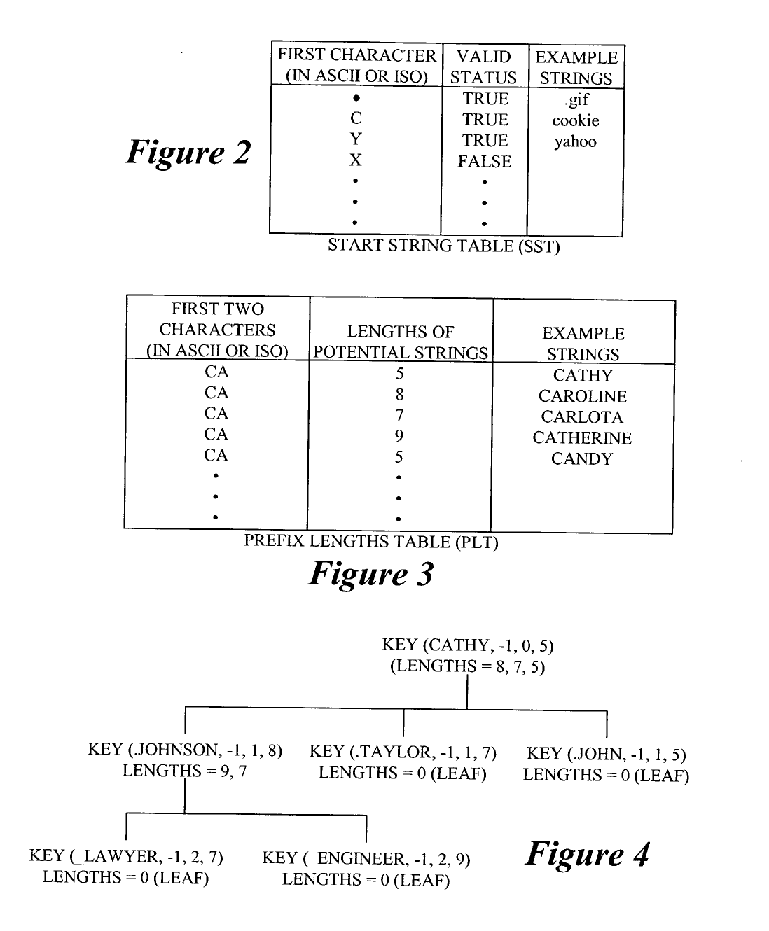

FIG. 1 illustrates a flow diagram of an exemplary string matching method 100 in accordance with an embodiment of the invention. In step 102 of the method 100, a start string table (SST) is searched to find out if the first ASCII character (i.e. first byte) of the start string is in the SST. The SST contains a column (e.g. an address) listing possible first characters (in ASCII or ISO) of all strings, and a second column indicating (true or false) whether the first character starts a valid string. For instance, as shown in FIG. 2 the SST may include valid strings such as “.gif”, “cookie”, and “yahoo”, etc. Thus, if the start string has a first character that starts with “.”, “c”, and “y”, then the SST indicates a true valid string for the string matching process. If the first character of a starts string is “x”, then the SST indicates an invalid (false) start string. Accordingly, the SST serves as a filter to quickly eliminate invalid start strings.

As follows, in step 104 of the string matching method 100, a determination is made as to whether the first character (i.e. first byte) of the start string is in the SST. If it is not, in step 106 the start string is deemed to be invalid. If the first character of the start string is valid, then in step 108 the start search index (SSI) and the current search index (CSI) are set to point to the first character of the start string. The SSI indexes the root of any potentially matching string. The CSI indexes the current portion of the string undergoing the string matching process.

In step 110 of the string matching method 100, the first and second characters (e.g. in ASCII or ISO representation) are used to index a prefix lengths table (PLT) to find out lengths for potential matching first strings. An exemplary PLT is shown in FIG. 3. The PLT may be configured to have a first column (e.g. an address) listing the first and second characters (e.g. in ASCII or ISO representation) of matching strings and a second column showing the corresponding lengths. For example, if the first two characters of the start string are “CA”, then there may be five lengths 5, 8, 7, 9, and 5 for valid matching strings such as “Cathy”, “Caroline”, “Carlota”, “Catherine”, and “Candy”, respectively. As follows, the lengths are used to form hash keys for a hash table containing the root string match and possibly other continuing string matches.

In step 112 of the method 100, a hash key is formed comprising the start string of length N, a parameter of −1 (i.e. Is filled on a byte basis if the string length N is less than 20 bytes, where 20 bytes is an arbitrary size for a hash key), a previous field Prev to index the previous hash table entry if the current string is a continuing portion of a string greater than 20 bytes, and a prefixed length field indicating the length N of the current string. As shown in FIG. 4, an exemplary root hash key may look as follows:

Key (Cathy, −1, 0, 5)

where “Cathy” is the root string, −1 represent the ones filled to 20 bytes, 0 represents the previous level which for the root case is 0, and 5 represents the length of the string “Cathy”.

In step 114 of the string matching method 100, a determination is made as to whether there is a hash key with a string matching the input string. If there is, in step 116 a determination is made as to whether the corresponding hash entry has a leaf (i.e. length=0). If it does, then in step 118, a successful matching string has been determined, and the process may perform a particular operation, such as route a data packet to a certain port or other operations. If in step 116 it is determined that the hash entry does not have a leaf (i.e. a length=0), in step 120 the lengths of potential continuing strings are found in the current hash entry and in step 122 the CSI is updated to point to the beginning of the next string. The method 100 then returns back to step 112 to form new hash keys based on the lengths found in the current hash entry. Then steps 114, 116 and possibly 120 and 122 are repeated until a hash entry containing leaf (i.e. length=0) is found indicating a successful matching string.

If in step 114 it is determined that there arc no hash entry with a string matching the input string, then in step 124 a determination is made as to whether there is a shorter string to be used for the string matching method. For example, if the initial string is “Catherine_Johnson” and no hash entry having a matching string has been located, the initial string can be shortened to “Catherine” and the hash key forming step can proceed using the shortened string. Accordingly, if the inquiry of step 124 is answered in the affirmative, then in step 126 the shortened string is selected and the method 100 returns back to step 112 to form the hash keys with the shortened string.

If in the inquiry of step 124 is answered in the negative, then the method 100 proceeds to step 128 where the SSI is advanced to a next position of the input string. For instance, if the input string mistakenly has an extra character in front of a name % Cathy, then an initial search may not result in a root has entry. Thus, in step 128, the SSI is advanced to point to the letter “C” in Cathy, and the method 100 returns back to step 102 to repeat the process using “C” as the starting letter of the input string.

FIG. 4 illustrates an exemplary hash table in the form of a parse tree in accordance with another embodiment of the invention. As illustrated the root key is Key (Cathy, −1, 0, 5). The root key does not have a leaf, but has several lengths 8, 7 and 5 of potential matching continuing strings. When step 112 is repeated for the first time, new second-level Keys may be formed as follows:

Key (.Johnson, −1, 1, 8)

Key (.Taylor, −1, 1, 7)

Key (.John, −1, 1, 5)

In step 114, the Key that is first used to find a corresponding hash entry is the Key with the longest length. In this example, the Key (.Johnson, −1, 1, 8) is the first one to be used. Otherwise, a false matching may occur if for example the Key (.John, −1, 1, 5) may cause an access of hash entry Key (.Johnson, −1, 1, 8) because they have common prefixes.

If for example, the Key (.Taylor, −1, 1, 7) or the Key (John, −1, 1, 5) results in a string match, the string matching process ends since they each have a leaf (i.e. length=0) indicating no more continuing strings and a successful string match. If, on the other hand, the Key (.Johnson, −1, 1, 8) results in a match, then there are more lengths for continuing strings in the corresponding hash entry. Subsequent Keys may be formed to find out the matching hash entry for continuing strings, such as for example Key (_Lawyer, −1, 2, 7) and Key (_Engineer, −1, 2, 9).

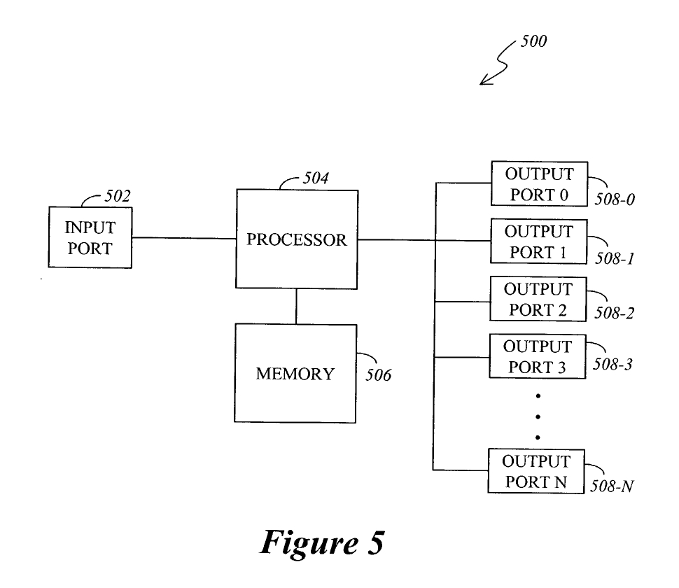

FIG. 5 illustrates a block diagram of an exemplary routing device 500 in accordance with another embodiment of the invention. The routing device 500 comprises an input port 502, a processor 504, a memory 506, and a plurality of output ports 508-1-N. The input port 502 receives a data packet containing a string to undergo the string matching process. The string matching process software and data resides in the memory 506, which can be accessed by the processor 504. The processor 504 performs the string matching process to find a hash entry containing a leaf indicating a successful string match as explained above. The hash entry containing the leaf will also have further instruction as to which one or more output ports 508-N is the data packet to be routed. This example is merely one application of the string matching process.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of recognizing an input string comprising:
searching for lengths of potential matching strings using one or more characters of said input string;
generating hash keys respectively comprising the input string and lengths of potential matching strings; and
searching a hash table using said hash keys to find a hash entry containing a string matching said input string.

2. The method of claim 1, wherein searching for lengths of potential matching strings comprises searching a prefix length table (PLT) containing lengths of potential matching stings associated with said one or more characters of said input string.

3. The method of claim 1, further comprising determining whether said input string is a valid string.

4. The method of claim 3, wherein determining whether said input string is valid comprises searching a start string table (SST) for the first character of said input string.

5. The method of claim 1, wherein said input string comprises a portion of a total string, and wherein each of said hash keys further comprises an index indicating the order sequence of the input string within said total string.

6. The method of claim 1, wherein said hash entry includes a parameter indicating that there are no further strings to search.

7. The method of claim 1, wherein said hash entry includes one or more lengths of potential matching strings that continue said input string.

8. An apparatus for recognizing an input string comprising a processor to:
search for lengths of potential matching strings using one or more characters of said input string;
generate hash keys respectively comprising the input string and respective lengths of potential matching strings; and
search a hash table using said hash keys to find a hash entry containing a string matching said input string.

9. The apparatus of claim 8, further comprising a memory for storing a prefix length table (PLT) containing lengths of potential matching strings associated with said one or more characters of said input string, and wherein said processor searches for lengths of potential matching strings by searching said prefix length table (PLT).

10. The apparatus of claim 8, wherein said input string comprises a portion of a total string, and wherein each of said hash keys further comprises an index indicating the order sequence of the input string within said total string.

11. The apparatus of claim 8, wherein said hash entry includes a parameter indicating that there are no further strings to search.

12. The apparatus of claim 8, further comprising:
an input port to receive a data packet comprising said input string;
a plurality of output ports; and
wherein said processor to cause a routing of said data packet to a selected output port based on finding said string matching said input string.

13. The apparatus of claim 8, wherein said hash entry includes one or more lengths of potential matching strings that continue said input string.

14. A computer readable medium for recognizing an input string comprising one or more software modules to:
search for lengths of potential matching strings using one or more characters of said input string;
generate hash keys respectively comprising the input string and lengths of potential matching strings; and
search a hash table using said hash keys to find a hash entry containing a string matching said input string.

15. The computer readable medium of claim 14, wherein said one or more software modules searches for lengths of potential matching strings by searching a prefix length table (PLT) containing lengths of potential matching strings associated with said one or more characters of said input string.

16. The computer readable medium of claim 14, wherein said one or more software modules to determine whether said input string is a valid string.

17. The computer readable medium of claim 16, wherein said one or more software modules to determine whether said input string is valid by searching a start string table (SST) for the first character of said input string.

18. The computer readable medium of claim 14, wherein said input string comprises a portion of a total string, and wherein each of said hash keys further comprises an index indicating the order sequence of the input string within said total string.

19. The computer readable medium of claim 14, wherein said hash entry includes a parameter indicating that there are no further strings to search.

20. The computer readable medium of claim 14, wherein said hash entry includes one or more lengths of potential matching strings that continue said input string.
